(19) United States
(12) Patent Application Publication
(10) Pub. No.: US 2026/0278099 A1
(43) Pub. Date: Sep. 17, 2026

(54) METHODS OF DETERMINING ENTROPY FOR PERSISTENT STORAGE DEVICES

(71) Applicant: Daedalus Cloud LLC, Croton-on-Hudson, NY (US)

(72) Inventor: Stuart John Inglis, Hamilton (NZ)

(21) Appl. No.: 19/471,627

(22) PCT Filed: Apr. 15, 2024
(86) PCT No.: PCT/US2024/024643

§ 371 Date: Oct. 1, 2025

Related U.S. Application Data
(60) Provisional application No. 63/497,202, filed on Apr. 19, 2023.

(51) Int. Cl. G06F 21/56

(52) U.S. Cl. CPC G06F 21/566; G06F 2221/034

(57) ABSTRACT

A method of determining entropy for a persistent storage device. A request to write data at a virtual location is received. An entropy for the data is determined and the determined entropy is compared to a reference entropy. A likelihood that the data is consistent with a ransomware attack is determined is based, at least partially, on the comparison between the determined entropy and the reference entropy.

### RELATED APPLICATIONS

This application is a National Stage under 35 USC 371 of and claims priority to International Application No. PCT/US2024/024643, filed 15 Apr. 2024, which claims the priority benefit of U.S. Provisional Application No. 63/497,202, filed 19 Apr. 2023.

### FIELD OF THE INVENTION

This relates to methods of determining entropy for persistent storage devices.

### BACKGROUND

Ransomware is a known type of malware that maliciously encrypts the data of a user. Data which has been maliciously encrypted can have a high entropy.

### SUMMARY OF THE INVENTION

In a first example embodiment, there is provided a method comprising: receiving a request to write data at a virtual location; determining an entropy for the data; comparing the determined entropy to a reference entropy; and determining a likelihood that the data is consistent with a ransomware attack; wherein the determined likelihood is based at least partially on the comparison between the determined entropy and the reference entropy.

Preferably, the method further comprises: aborting a write process based at least partially on the determined likelihood.

Preferably, the method further comprises: writing the data to the virtual location; and writing the determined likelihood to metadata at the virtual location.

Preferably, the reference entropy is based at least partially on an average of a plurality of previous entropies.

Preferably, the reference entropy is an upper threshold.

Preferably, the reference entropy corresponds to an entropy of an expected data source.

Preferably, the reference entropy corresponds to an entropy of a known data source.

Preferably, comparing the determined entropy to a reference entropy comprises a threshold test.

Preferably, the determined likelihood is proportional to a difference between the determined entropy and the reference entropy.

Preferably, the method further comprises applying a margin of uncertainty to the determined entropy.

Preferably, the method further comprises applying a margin of uncertainty to the reference entropy.

Preferably, the margin of uncertainty is a standard deviation.

In a second example embodiment, there is provided a method comprising: receiving a request to write data at a virtual location; determining an entropy signature for the data; evaluating the determined entropy signature; and determining a likelihood that the data is consistent with a ransomware attack; wherein the determined likelihood is based at least partially on the evaluation of the determined entropy signature.

Preferably, evaluating the determined entropy signature comprises comparing at least a portion of the determined entropy signature to at least a portion of a reference entropy signature.

Preferably, the reference entropy signature corresponds to an entropy signature of an expected data source.

Preferably, the reference entropy signature is a whitelisted entropy signature.

Preferably, the reference entropy signature is a blacklisted entropy signature.

Preferably, the determined likelihood is proportional to a deviation between the at least a portion of the determined entropy signature and the at least a portion of the reference entropy signature.

Preferably, evaluating the determined entropy signature comprises comparing at least a portion of the determined entropy signature to at least one reference entropy.

Preferably, the determined likelihood is proportional to a deviation between the at least a portion of the determined entropy signature to the at least one reference entropy.

Preferably, evaluating the determined entropy signature comprises classifying the entropy signature using a trained machine learning model.

### BRIEF DESCRIPTION OF THE DRAWINGS

The description is framed by way of example with reference to the drawings which show certain embodiments. However, these drawings are provided for illustration only, and do not exhaustively set out all embodiments.

FIG. 1 shows an example storage system.

FIG. 2 shows an example approach of a storage controller handling a write request to a persistent storage device.

FIG. 3 shows a worked example of a storage controller writing data.

FIG. 4 shows an example entropy signature.

FIG. 5 shows an example approach of a storage controller handling a write request to a persistent storage device.

FIG. 6 shows a further example approach of a storage controller handling a write request to a persistent storage device.

### DETAILED DESCRIPTION

Ransomware is a type of malware which maliciously encrypts data stored on a persistent storage device. The maliciously encrypted data is then inaccessible to its legitimate owner until it has been decrypted. Decryption of the data is not realistically possible without the corresponding key which is held by the perpetrator of the ransomware attack. This allows the perpetrator of the ransomware attack to extort the legitimate owner of the data. If the ransomware attack is detected sufficiently early, it can be possible to mitigate the damage and retrieve the associated data. Data which has been encrypted with ransomware is referred to as ‘maliciously encrypted data’ in this specification, and such data is said to correspond with a ransomware attack.

By way of background, the Shannon entropy of a source of data (such as a process which generates or modifies data) is a measure of the expected amount of information or randomness in data produced by that process. Without loss of generality, the Shannon entropy H(X) of a discrete random variable X can be defined as:

$$H ( X ) = - {\sum }_{i = 1}^{n} P ( {x}_{i} ) {log}_{2} P ( {x}_{i} )$$

where xᵢ, . . . , xₙ are the possible outcomes of X and P(xᵢ), . . . , P(xₙ) are their respective possibilities. Other definitions of the Shannon entropy may use logarithms of a different basis. Similarly, other measures of entropy can also be defined and used.

Entropy is therefore defined for a distribution of discrete outcomes, and its value depends on the probability of the outcomes within the distribution. It can be shown that a distribution in which all outcomes are equally probable has a maximum entropy, while a distribution with non-uniform probabilities has a lower entropy. A distribution which always produces a single outcome with 100% probability has an entropy of zero.

For example, consider a process X that generates a byte consisting of 8 bits. The generated byte can take 256 possible values ranging from 0 to 255. If the process X has a uniform distribution and is equally likely to produce bytes of all possible values (i.e., each byte value has a probability of

$$\frac{1}{256} ) ,$$

then it can be shown that the entropy of X is 8. This is the maximum possible entropy for a source that produces a byte of data, which can be the smallest unit of addressable memory for several computer architectures. Other computer architectures may use a smaller or larger smallest unit of addressable memory.

In cases such as the example above where the data source X and probabilities P(xᵢ), . . . , P(xₙ) are known and well characterized, the entropy of X can be determined analytically or with a high degree of confidence. In other cases, a data source may not be known or well characterized, and the entropy of the data source may need to be inferred from data produced by the data source.

For example, consider a file of a finite size produced by a process X. It is known that the process X produces bytes which have 256 possible values, but the probability of each of those values may be unknown, meaning that the entropy of X is unknown. However, the probability that X produces a byte of a given value can be estimated by counting the total number of bytes of that value occurring within the file, and then dividing that count by the total number of all bytes within the file. A histogram of the different byte values for the file can be used for this purpose.

After the probabilities P(xᵢ), . . . , P(xₙ) of xᵢ, . . . , xₙ have been estimated, the entropy of the underlying process can then be estimated using the equation for the Shannon entropy given above. The accuracy of this estimate will usually depend at least partially on the total size of the file, as the total size corresponds to the number of samples used to infer the probability distribution of X. Although this process estimates the entropy of the underlying process that was used to create the file, the estimated entropy can be referred to as the ‘entropy of the file’, ‘entropy of the data’, or similar terms.

The encryption methods and algorithms used in ransomware attacks often have a high entropy or a particular entropy signature. This can be used to detect or flag files or data which may correspond to a ransomware attack before or as they are being written to persistent storage.

Approaches for a storage controller are described which allow the storage controller to handle requests to write data on a persistent storage device. The persistent storage device is a system for storing data in a persistent manner and may consist of one drive or multiple drives in different configurations. The storage controller may store data that is to be written in a cache before the data is stored on the persistent storage device. This can allow the storage controller to estimate the entropy of data before it has stored on the persistent storage device. In other examples, a cache may not be used.

The cache (if present) has multiple cache lines. Each cache line is a division of the cache which is read and written to in a single unit. Each cache line may have capacity for a predetermined number of pages. A page is a unit of data set by a processor architecture, which may be 4 KiB (4096 bytes). A cache line can be configured to store 63 pages.

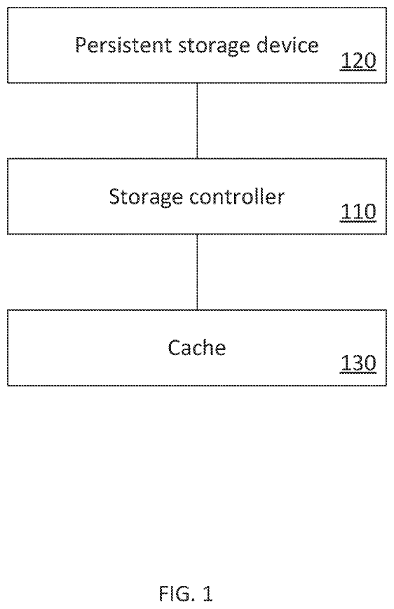

FIG. 1 shows an example storage system.

The storage controller 110 is in communication with a persistent storage device 120. The persistent storage device 120 is a system for storing data in a persistent manner. The persistent storage device 120 may comprise a drive (such as a hard disk drive or solid state drive) or an array of drives arranged into one or more groups and distributed over a number of storage nodes.

Data is stored on the persistent storage device 120 in blocks. A block is a unit of data of predetermined size. In some examples, a block may have a size of 4 KiB (4096 bytes). The storage controller 110 can be configured to use logical block addressing when receiving requests to interact with persistent storage device 120. The storage controller 110 can also be configured to store data in stripes of blocks. The data can be erasure encoded and the array of drives may be configured in a k-parity arrangement.

The storage controller 110 of the example storage system 100 can communicate with a cache 130. The cache 130 comprises non-volatile memory configured to operate as a non-volatile cache. Other storage systems may omit a cache.

Although the storage controller 110 is described as a single component, the different functions of the storage controller 110 may be split across multiple entities. For example, interactions with cache 130 may occur through a cache controller independent of storage controller 110.

### Writing Data

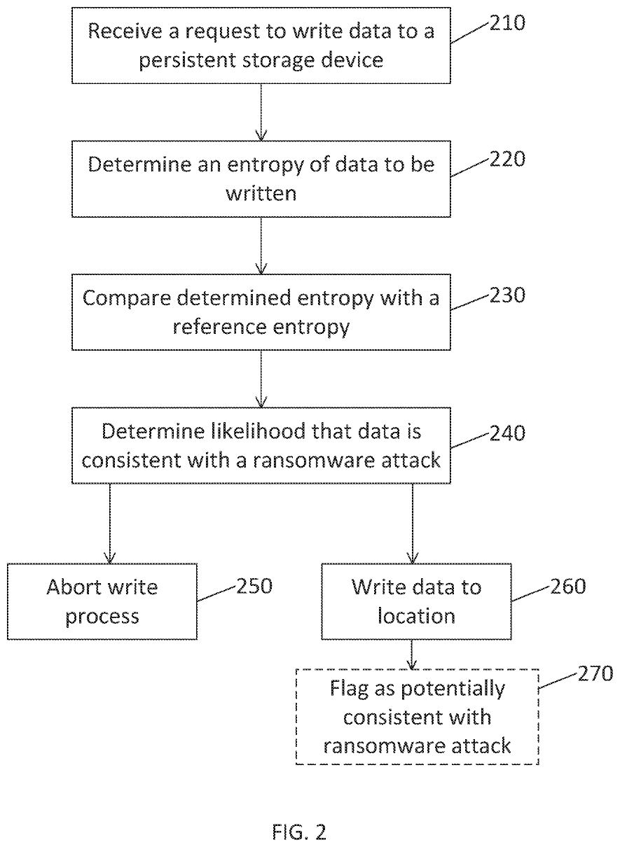

The storage controller is configured to administer writing data to the persistent storage device. The storage controller can calculate or determine the entropy of data that is to be written or is in the process of being written to the persistent storage device. FIG. 2 shows one example approach through which the storage controller can handle a write request to write data to a persistent storage device. This may be implemented in a storage controller running on a system.

At step 210, a request is received to write data at a location of the persistent storage device. The request may be received by a function call of the storage controller. The request may comprise the data or may comprise a pointer to where the data may be retrieved from (for example, a memory address). The request may also comprise an identifier of the location to which the data is to be written, such as a block index and disk identifier. The location to which the data is to be written may comprise a line of a cache.

At step 220, the storage controller determines an entropy of the data that is to be written. In some examples, the storage controller may calculate the entropy of the data that is to be written. In other examples, the storage controller may be provided with the calculated entropy of the data that is to be written. The entropy of the data that is to be written may be calculated from the data comprising the write request or may be calculated by using the pointer to where the data may be retrieved from.

At step 230, the storage controller compares the determined entropy of the data to a reference entropy. The reference entropy may be retrieved from metadata for the persistent storage device. The reference entropy can also or alternatively be provided to the storage controller as part of the write request. For example, the reference entropy may be the entropy of the data that was previously written at that location.

At step 240, the storage controller determines a likelihood that the data is consistent with a ransomware attack. The determination is based at least partially on the comparison made at step 230. In some examples, the determined likelihood may be a percentage or probability that the data is consistent with a ransomware attack. The data may further be flagged as suspected maliciously encrypted data based at least partially on its determined probability. In other examples, the determined likelihood may not be a percentage or probability, and the storage controller may simply classify the data as suspected maliciously encrypted data or non-suspicious data.

If the storage controller determines that the data is consistent with a ransomware attack and the data is flagged or classified as suspected maliciously encrypted data, the storage controller may abort the write process at step 250. The storage controller may also initiate an incident response and may update metadata or write metadata for the persistent storage device. The incident response may involve a re-evaluation of data that the storage controller previously flagged as potentially consistent with ransomware. Other potential countermeasures that the storage controller may alternatively or additionally take can include reducing a write speed and/or raising an alert.

If the storage controller does not suspect that the data is maliciously encrypted, the storage controller writes the data to the intended location at step 260. The storage controller may also write metadata to the intended location and a checksum. The metadata can comprise the determined entropy of the data, the likelihood that the data is consistent with a ransomware attack, the reference entropy used in the comparison at step 230, and/or a timestamp.

In some approaches, the storage controller may also proceed to write the data to the intended location at step 260 if the storage controller determines that the data may be consistent with a ransomware attack, but the determined likelihood is not sufficiently high to flag the data as suspected maliciously encrypted data. In these cases, the storage controller may flag the data as potentially consistent with a ransomware attack at 270. Such a flag may be written to the metadata at the intended location and/or the logical block address may be flagged in metadata for the persistent storage device. Additional metadata may also be written to the intended location and/or the array for the persistent storage device.

### Reference Entropies

In some examples, the reference entropy used for the comparison can be related to the average entropy of data that the storage controller has previously written or has handled via write requests. For example, the reference entropy may be determined by calculating the average of a rolling window of blocks, stripes, pages, or cache lines of data previously written by the storage controller or previously received within write requests by the storage controller. Entire blocks (e.g., data, metadata, checksums, etc.) can be averaged or only sub-portions may be averaged. The rolling window may be bounded in terms of a number of units of data (e.g., the previous 10,000 blocks of data) or in terms of time (e.g., all blocks written within the previous hour.)

If the reference entropy is stored within the metadata of the permanent storage device, then the reference entropy can be updated at the end of each write event at step 260 using the example approach depicted in FIG. 2. If the reference entropy is determined using a rolling mean of stripes of data, then the storage controller may be configured so that the reference entropy is updated at step 260 only if the writing of data at step 260 coincides with the termination of a stripe. The reference entropy can also be determined by periodically averaging the entropies that are written to the metadata of previous blocks.

In other examples, the reference entropy may not be determined by a rolling average of previous data and may be a static number. For example, the reference entropy can be an upper threshold. The value of the reference entropy can be chosen so that any file with an entropy above the upper threshold is likely to be strongly encrypted and consistent with a ransomware attack. For example, in a system which uses a byte-based architecture (i.e., where the maximum hypothetical entropy is 8), the reference entropy may have a value of 7.8, 7.9, or 7.99. The reference entropy may have a different value depending on the application of the storage controller. Furthermore, the reference entropy will differ for other systems which use a different underlying architecture with a different maximum hypothetical entropy.

In still further examples, the reference entropy may be determined using knowledge about the processes of data generation that are used with the persistent storage device. For example, some or all the different approaches to encryption and compression that are legitimately used to generate or modify data handled by the storage controller may be known, and their corresponding entropies (or estimates of their corresponding entropies) may also be known. The value of the reference entropy may be set to a value greater than the entropies of the known encryption and compression techniques used in conjunction with the persistent storage device. If the entropy of the data determined at step 220 is higher than the reference entropy, then the data may correspond to a data source with a higher entropy than known sources used legitimately with the storage controller and persistent storage device.

In still further examples, the reference entropy may be determined using information known about the underlying process expected to have produced the data received in the request at step 210. For example, if the storage controller anticipates that an expected data source has produced the data received in the request at step 210, and the entropy of the expected data source is known, then the reference entropy can be based at least partially on the entropy of the expected data source. If the entropy of the data determined at step 220 differs from the reference entropy, then the data source used to produce the data in the request is ‘unexpected’ and may be consistent with a ransomware attack. The storage controller may anticipate that an expected data source is to be used based on historical events or patterns (e.g., certain data processes being used consistently at certain times of the day), indications received within the write request, the originating source of the write request itself, and/or knowledge about the underlying system.

Comparison with Reference Entropy

The reference entropy used in the comparison at step 230 is a quantitative number. Because ransomware typically uses strong encryption with a very high entropy as a data source, the reference entropy used in the comparison at step 230 is typically an upper threshold. Generally speaking, if the entropy of the data is above the reference entropy (or equal to or above the reference entropy in some examples), then the storage controller may ascribe a non-zero likelihood that the data is consistent with a ransomware attack.

In some examples, the comparison at step 230 may be a simple threshold test. If the entropy of data is above (or equal to or above) the reference entropy, then the storage controller can either flag the data as suspected maliciously encrypted data and/or can ascribe a likelihood that the data is consistent with a ransomware attack.

In other examples, the likelihood that the data is consistent with a ransomware attack ascribed by the storage controller at step 240 can be proportional to (or otherwise based on) the difference between the entropy of the data and the reference entropy. For example, if the entropy of the data is only slightly above the reference entropy, then the storage controller may ascribe a relatively low likelihood of the data being consistent with a ransomware attack. The likelihood may be insufficient to trigger the storage controller to flag the data as suspected maliciously encrypted data despite the fact that the entropy of the data is above the reference entropy, depending on how the storage controller is configured. Conversely, if the entropy of the data is significantly above the reference entropy, then the storage controller may ascribe a higher likelihood to the data at step 240 and may proceed to abort the write operation at step 250.

The entropy of the data which is determined at step 220 is based on a finite amount of data, which is effectively a finite sampling of the underlying probability distribution of the data source. Errors or variations in the measured entropy can therefore be caused by sampling effects. Similarly, if the reference entropy used in the comparison at step 230 is based on historic or averaged data, then the reference entropy is also based on a finite sampling of underlying probability distributions and may also suffer from errors or variations in measurements.

For example, consider a first legitimate data source which has an entropy less than a reference entropy. Data which is produced by the first data source should ideally have an entropy below the reference entropy, and therefore should not be considered as suspected maliciously encrypted data by the storage controller at step 230. However, it is possible for the first data source to produce a finite amount of data which has an entropy higher than the first entropy of the underlying data source, and the storage controller could flag this as suspected maliciously encrypted data based on the comparison at step 230. The storage controller therefore could falsely flag the finite data produced by the first data source as suspected maliciously encrypted data, even though the data is legitimate.

Similarly, consider a second data source which has an entropy higher than a reference entropy. Data which is produced by the second data source should ideally have an entropy above the reference entropy, and the storage controller therefore should suspect that data produced by the second data source is suspected maliciously encrypted data (or at least ascribe a non-zero likelihood of correspondence to a ransomware attack depending on how the storage controller is configured). However, it is possible for the second data source to produce a finite amount of data which has an entropy below the reference entropy, and the storage controller could fail to flag this data as suspected maliciously encrypted data (or fail to ascribe a non-zero likelihood) based on the comparison at step 230. The storage controller therefore could flag the finite data produced by the second data source as a false negative, even though the underlying data source may be consistent with a ransomware attack.

To this end, the entropy of the data and/or the reference entropy used in the comparison at step 230 may include one or more margins of uncertainty. The margins of uncertainty that are applied may be positive and/or negative. In other examples, margins of uncertainty may not be used.

In some examples, the margins of uncertainty can be static quantitative numbers in appropriate units (e.g., Shannons). For example, the entropy of the data (and/or the reference entropy) used in the comparison at step 230 may be provided with margins of uncertainty of ±0.5, ±0.1, or some other value as appropriate and in appropriate units. In other examples, the margins of uncertainty may be expressed as a percentage of the data/reference entropy. For example, the entropy of the data (and/or reference entropy) used in the comparison at step 230 may be provided with margins of uncertainty of ±10%, ±1%, or some other value as appropriate.

In other examples, the margins of uncertainty may be based on historic data or statistical measurements. For example, the margin of uncertainty applied to the entropy of the data and/or the reference entropy can be equivalent to a standard deviation or standard error based on previous calculated entropies. For example, if the reference entropy is determined using an average or rolling window of previous entropies, then the margin of uncertainty can be calculated using the variance of the previous entropies within the rolling window.

The margins of uncertainty can be used in the entropy comparison at step 230 and when determining a likelihood of correspondence with a ransomware attack at step 240. For example, the comparison at step 230 may be a threshold test so that data with an entropy higher than the reference entropy may be flagged as suspected maliciously encrypted data at step 240, while data with an entropy lower than the reference entropy may not be suspicious. However, if the reference entropy includes a margin of uncertainty, the entropy of the data may be higher than the reference entropy but within the margin of uncertainty of the reference entropy. Similarly, the entropy of the data may be lower than the reference entropy but still within the margin of uncertainty of the reference entropy. In these cases, the storage controller can flag the data as possible maliciously encrypted data at step 240 or may otherwise determine that the comparison at step 230 is inconclusive.

Similarly, if a percentage or probability is ascribed by the storage controller at step 240, then the percentage or probability may depend on the margin(s) of uncertainty. For example, if the margin of uncertainty represents a standard deviation, then the margin of uncertainty can be used as a confidence interval. The confidence interval can then be used to determine the compounded likelihood that firstly, the reference entropy is accurate, and secondly, that the data is suspected maliciously encrypted data given the comparison at step 230. The margins of uncertainty may be used in other ways at step 230 or step 240 depending on the application and configuration of the storage controller.

### Worked Example of Writing Data

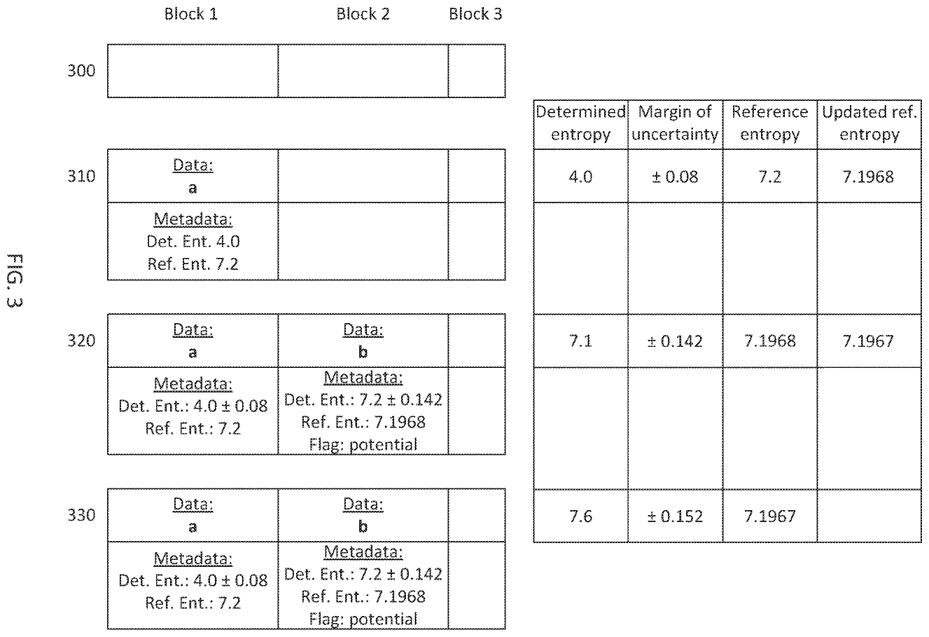

FIG. 3 shows a worked example of writing data. In this example, a margin of uncertainty of ±2% is applied to the determined entropies of data. It should be understood that the choice of 2% is purely for illustration and other approaches may use other margins of uncertainty, or may not apply margins of uncertainty to the determined entropies. Furthermore, no margin of uncertainty is applied to reference entropy in this illustrative example. In other approaches, a margin of uncertainty may be applied to the reference entropy.

Furthermore, the reference entropy used for comparison in the worked example depicted in FIG. 3 is a rolling average of the entropies of the previous 1,000 blocks of data. Purely for the sake of simplifying calculation, it is assumed that the previous 1,000 entropies were exactly equal to 7.2.

The state of the example persistent storage device is initially shown at 300, before the storage controller has written any data. Blocks 1 to 3 are initially empty. The storage controller first receives a request to write data a to block 1 at 310. The storage controller determines the entropy of the data to be 4.0. The storage controller accesses a reference entropy of 7.2 from the metadata for the persistent storage device, applies a 2% margin of uncertainty to the determined entropy for data a of ±0.08, and compares the determined entropy of 4.0±0.08 against the reference entropy of 7.2. The determined entropy is below the reference entropy and the storage controller proceeds to write data a to block 1.

The storage controller also writes metadata comprising the determined entropy of 4.0, the margin of uncertainty of ±0.08, and the reference entropy of 7.2 to the block. Other metadata may be written such as a checksum and/or a counter, such as a block counter or index counter. The storage controller then calculates a new reference entropy of 7.1968 based on the entropy of data a. The metadata for the persistent storage device is updated to reflect the updated reference entropy.

The storage controller then receives a request to write data b at block 2 at 320. The storage controller determines the entropy of the data to be 7.1. The storage controller accesses the reference entropy of 7.1968 from the metadata for the persistent storage device, applies a 2% margin of uncertainty of ±0.142 to the determined entropy of data b, and compares the determined entropy of 7.1±0.142 to the reference entropy of 7.1968.

In this case, the determined entropy is below the reference entropy before margins of uncertainty are applied, but is above the reference entropy once a margin of 2% has been applied. In this worked example, the storage controller is configured to write such data to its intended location whilst flagging the data as potentially consistent with a ransomware attack (corresponding to 270 with respect to FIG. 2.) The storage controller therefore proceeds to write the data b to block 2 whilst flagging the data as potentially consistent with a ransomware attack. The storage controller also writes metadata comprising the determined entropy of 7.1 and the reference entropy of 7.1968 to the block, and a flag indicating that the data is potentially consistent with a ransomware attack. The storage controller may alternatively (or additionally) update the metadata for the persistent storage device to indicate that data b at block 2 may be maliciously encrypted. The storage controller then calculates a new reference entropy of 7.1967 to the metadata for the persistent storage device.

The storage controller then receives a request to write data c at block 3 at 330. The storage controller determines the entropy of the data to be 7.6. The storage controller accesses the reference entropy of 7.1967 from the metadata for the persistent storage device, applies a 2% margin of uncertainty of ±0.152 to the determined entropy of c, and compares the determined entropy of 7.6 of ±0.152 to the reference entropy of 7.1967.

In this case, the determined entropy is above the reference entropy even after the margins of uncertainty have been applied. The storage controller aborts the write process on the basis of this comparison (corresponding to step 250 with respect to FIG. 2) and initiates an incidence response.

### Entropy Signatures

In the example approaches discussed above, the entropy of data is calculated as a single quantitative number. In other examples, alternatively to (or in addition to) a quantified entropy for the entire data, an entropy signature of the data can be determined. The entropy or entropies of certain portion(s) of the data can be calculated to build up an entropy signature.

For example, consider a block of data 4 kilobytes in size. Instead of (or in addition to) calculating the entropy of the entire 4 kilobyte block as discussed previously, the entropy of a subset of the 4 kilobyte block can be calculated. For example, the subset of data can be a window of data that is 1000 bytes in length. The window can start at the first byte of the block of data and the entropy of the data within the window can be calculated. The window can then be iteratively shifted by one byte (or by some other increment) towards the end of the block of data before calculating the entropy of the data within the window.

This process can be repeated and the window of data progressively moved towards the end of the block of data until the entire block of data has been covered. The calculated entropies can then be plotted against the corresponding position of the window within the data block to build an entropy signature. The entropy signature can then be used to identify high entropy or low entropy portions of data contained within the entire block of data and to identify where they occur within the entire block of data.

Considering the entropy signature of data that is to be written can be useful in addition to (or alternatively to) considering a single quantitative entropy for the entirety of the data to be written. For example, the storage controller may handle data that is legitimately encrypted with a high entropy, and therefore may be difficult to discern from maliciously encrypted data. However, the legitimately encrypted data may have low-entropy portions, portions of differing entropy, and/or entropy patterns that can be used as a ‘fingerprint’ to identify legitimate data. These finer details can potentially be subsumed in the remainder of the data when calculating a single entropy for the data that is to be written.

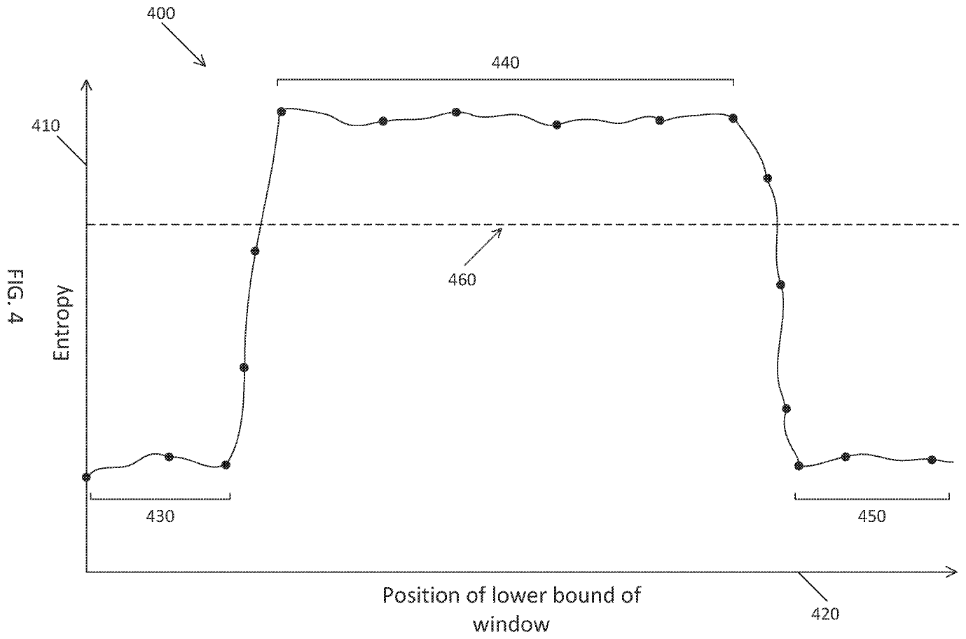

FIG. 4 shows an example of an entropy signature 400 of a block of data. The y-axis 410 corresponds to the determined entropy of data within a window or subset of the data, while the x-axis 420 corresponds to the position of the start of the window within the block of data. The determined entropy has been significantly smoothed for the sake of illustration; real-world entropy signatures can be significantly noisier.

It can be seen from the entropy signature 400 that the block of data includes an initial portion 430 which has a comparatively low entropy, a middle portion 440 which has a high relatively entropy, and a final portion 450 which also has a comparatively low entropy. For the sake of comparison, FIG. 4 also depicts an average entropy 460 which has been calculated over the entire block of data. This average entropy 460 shows how an entropy signature can reveal granular details that may otherwise be lost when determining the entropy of the entire block of data.

It will be apparent that the size of the block of data and the size of the window used to determine the entropy signature in the examples above are non-limiting and are merely illustrative. In some examples, the size of the data may be greater than or less than 4 KiB. Furthermore, the size of the window may be more or less than 1000 bytes. The size of the window may be based at least partially on the size of the data from which the entropy signature is being determined. The size of the window is preferably large enough to minimize sampling effects/errors when calculating the entropy of the data within the window, while also being small enough to produce an entropy signature with sufficient granularity to identify low-entropy and high-entropy subsets of data within the entire set of data.

In some cases, entropy may be calculated based on a write across multiple disks in an array. For example, the entropy may be calculated for all blocks in a stripe.

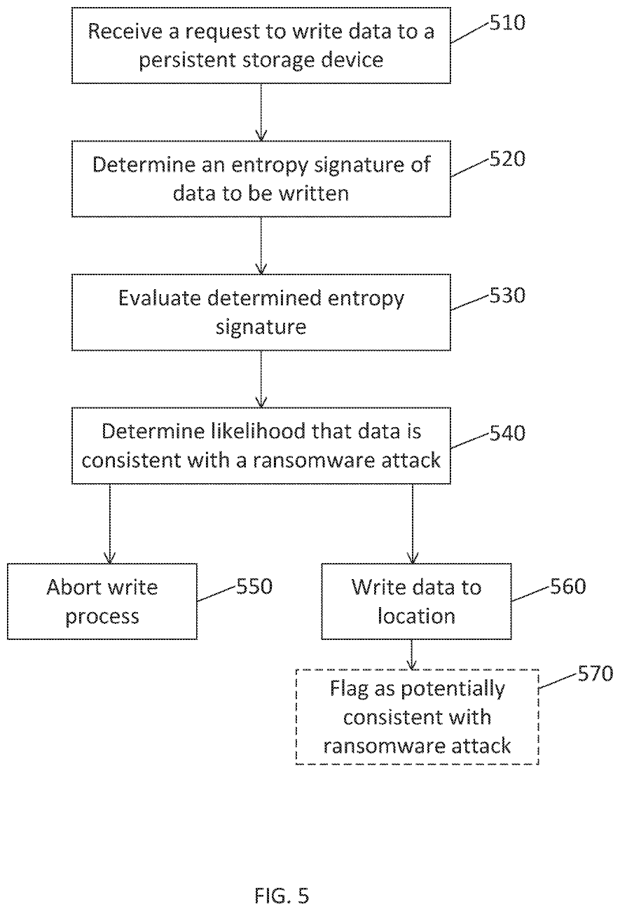

Entropy signatures can be used to at least partially determine whether a request to write data is consistent with a ransomware attack. FIG. 5 shows one example approach through which a storage controller can handle a write request to write data to a persistent storage device. This may be implemented in a storage controller running on a system.

At step 510, a request is received to write data at a location of the persistent storage device. The request may be received by a function call of the storage controller. The request may comprise the data or may comprise a pointer to where the data may be retrieved from (for example, a memory address). The request may also comprise an identifier of the location to which the data is to be written, such as a block index and disk identifier. The location to which the data is to be written may comprise a line of a cache.

At step 520, the storage controller determines an entropy signature of the data that is to be written. In some examples, the storage controller may calculate the entropy signature of the data that is to be written. In other examples, the storage controller may be provided with the entropy signature of the data that is to be written. The entropy signature of the data that is to be written may be determined from the data comprising the write request or may be determined by using the pointer to where the data may be retrieved from. The storage controller then evaluates the determined entropy signature at step 530.

At step 540, the storage controller determines a likelihood that the data is consistent with a ransomware attack. The determination is based at least partially on the evaluation made at step 530. In some examples, the determined likelihood may be a percentage or probability that the data is consistent with a ransomware attack. The data may further be flagged as suspected maliciously encrypted data based at least partially on its determined probability. In other examples, the determined likelihood may not be a percentage or probability, and the storage controller may simply classify the data as suspected maliciously encrypted data or not suspect.

In some cases, the likelihood may be dependent on a pattern of reads and writes. A read at a location followed by a write at the location may be more likely to be a ransomware attack, since that implies that data is being overwritten. In contrast, a write to a location which has not previously been read may be less likely to be a ransomware attack, since the data previously stored there has not been read (and therefore could not be rewritten encrypted).

If the storage controller determines that the data is consistent with a ransomware attack and the data is flagged or classified as suspected maliciously encrypted data, the storage controller may abort the write process at step 550. The storage controller may also initiate an incident response and may update metadata or write metadata for the persistent storage device. Other potential countermeasures that the storage controller may alternatively or additionally take can include reducing a write speed and/or raising an alert.

If the storage controller does not suspect that the data is maliciously encrypted, the storage controller writes the data to the intended location at step 560. The storage controller may also write metadata to the intended location and a checksum. The metadata can comprise the determined entropy signature of the data, the likelihood that the data is consistent with a ransomware attack, metadata relating to the evaluation at step 530, and/or a timestamp.

In some approaches, the storage controller may also proceed to write the data to the intended location at step 560 if the storage controller determines that the data may be consistent with a ransomware attack, but the determined likelihood is not sufficiently high to flag the data as suspected maliciously encrypted data. In these cases, the storage controller may flag the data as potentially consistent with a ransomware attack at 570. Such a flag may be written to the metadata at the intended location and/or the logical block address may be flagged in metadata for the persistent storage device. The storage controller may also write metadata and a checksum to the intended location. The metadata can comprise the determined entropy signature of the data, the likelihood that the data is consistent with a ransomware attack, metadata relating to the evaluation at step 530, and/or a timestamp.

### Evaluation of Entropy Signatures

The nature of the evaluation of the entropy signature at step 530 (with respect to FIG. 5) can depend on the application of the storage controller.

In some examples, the entropy signature determined at step 520 may be evaluated by comparing the determined entropy signature against one or more reference entropy signatures or portions of a reference entropy signature. One or more margins of error can be determined for the entropy signature determined at 520 and used for the evaluation at step 530, similar to the margins of error described with reference to the entropy calculated at 220 with respect to FIG. 2.

For example, if the storage controller anticipates that an expected data source has produced the data received in the request at step 510, then an expected entropy signature corresponding to the expected data source can be used as a reference entropy signature. The expected data source may be known to produce data which (for example) includes a header, and the expected entropy signature associated with the expected data source may begin with a low-entropy portion corresponding to the header. If the entropy signature determined at step 520 is compared against the expected entropy signature and is found to begin instead with a high-entropy portion, then the storage controller may determine that the data received at 510 is consistent with a ransomware attack at step 540. The comparison can take into account any margins of error assigned to the relevant portions of the entropy signature corresponding to the received data and the reference entropy signature.

In some examples, the comparison may only be between a relevant portion of the determined entropy signature and the reference entropy signature. For example, the comparison may be made between a low-entropy header in the reference entropy signature and the corresponding portion of the determined entropy signature. In other examples, the comparison may be between multiple portions (or the entirety of) the determined entropy signature and reference entropy signature. Deviations from different portions of the reference entropy signature may be given different weights when determining whether the entropy signature of the data is consistent with a ransomware attack at 540. For example, deviations from low-entropy headers or footers can be given a greater weight than deviations from the body of the entropy signature if appropriate.

In some examples, the storage controller may only be concerned with entropy signatures that deviate from an expected entropy signature by having a greater entropy in portion(s) of the entropy signature. For example, an expected entropy signature may have a low-entropy portion corresponding to a header and has a high-entropy portion corresponding to a body, whereas the entropy signature determined at 520 may have a low-entropy portion also corresponding to a header, and a body with an entropy that is less than the entropy of the body of the reference entropy signature. Although the determined entropy signature has a body portion with an entropy that is lower than the entropy of the corresponding portion of the reference entropy signature, the storage controller may not flag the data as suspected maliciously encrypted data on the basis that the deviations have a lower entropy than expected, rather than a higher entropy than expected. In other examples, the storage controller may still flag data as suspected maliciously encrypted data based on an entropy signature having deviations with a lower entropy than expected.

In some examples, the storage controller may access or receive a whitelist of entropy signatures (from, for example, metadata for the persistent storage device). The whitelist may include entropy signatures associated with some or all of known data sources that are legitimately used in conjunction with the persistent storage device and may be periodically updated by the storage controller to include entropy signatures of vetted data or data processes that the storage controller has previously written. The storage controller can then compare the entropy signature determined at step 540 with some or all of the entropy signatures contained within the whitelist. If the determined entropy signature is found to not match any of the whitelisted entropy signatures to a satisfactory degree, then the storage controller may determine that the data received with the request at 510 is consistent with a ransomware attack at step 540.

In other examples, the storage controller may access or receive a blacklist of entropy signatures. The blacklist may include entropy signatures associated with one or more data sources that are known to be or suspected to be associated with ransomware attacks. Such a blacklist may be periodically updated to include entropy signatures that the storage controller suspects to be (or knows to be) associated with or corresponding to ransomware attacks. The storage controller can then compare the entropy signature determined at 520 with some or all of the entropy signatures contained within the blacklist. If the determined entropy signature is found to match one or more of the blacklisted signatures (possibly within some margin of error), then the storage controller may determine that the data received with the request at 510 is consistent with a ransomware attack at step 540.

In still further examples, evaluating the entropy signature determined at step 520 can comprise comparing the determined entropy signature (or one or more portions of the determined entropy signature) to one or more reference entropies. For example, an upper entropy threshold can be determined for the head, footer, tail, or other portion of the entropy signature, and the corresponding portion of the determined entropy signature can be compared against the reference entropy. If the value of the entropy signature is greater than the reference entropy at the relevant location, then the storage controller may flag the data as suspected maliciously encrypted data or may assign a probability of the data being maliciously encrypted. Similar reference entropies can be determined for other portions of the entropy signature if desired. Multiple portions of the entropy signature can also be compared against multiple reference entropies.

In still further examples, evaluating the determined entropy signature can comprise classifying the determined entropy signature with a trained machine learning model. For example, the machine learning model may be trained to classify the data as maliciously encrypted based at least partially on the entropy signature of the data. The machine learning model may be a machine learning model trained using supervised data (e.g., a deep neural network) or may be a machine learning model trained using unsupervised data (e.g., a support vector machine.)

In yet further examples, the determined entropy signature can be evaluated at 530 using a combination of the above approaches. For example, the entropy signature determined at 520 may be evaluated by classifying the entropy signature with a machine learning model, comparing the entropy signature against a blacklist of entropy signatures, and comparing one or more portions of the entropy signature to one or more reference entropies. Other combinations of approaches can be used where appropriate.

### Combined Approaches

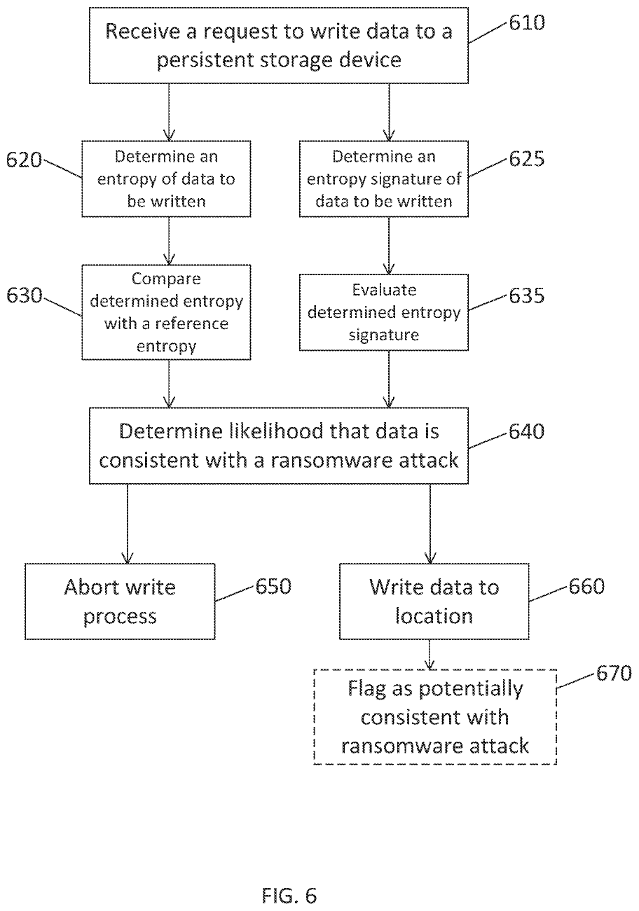

In some examples, a storage controller can use a combination of determined entropies (i.e., a single quantitative value determined for the entire amount of data) and entropy signatures to determine whether given data is consistent with a ransomware attack. FIG. 6 depicts one such example approach through which a storage controller can handle a write request to write data to a persistent storage device.

At step 610, a request is received to write data at a location of the persistent storage device. The request may be received by a function call of the storage controller. The request may comprise the data or may comprise a pointer to where the data may be retrieved from (e.g., a memory address). The request may also comprise an identifier of the location to which the data is to be written, such as a block index and disk identifier. The location to which the data is to be written may comprise a line of a cache.

At step 620, the storage controller determines an entropy of the data that is to be written. The storage controller may calculate the entropy of the data that is to be written or may be provided with the entropy signature of the data that is to be written, as has been described previously. The storage controller also determines an entropy signature of the data that is to be written at 625. The storage controller may calculate the entropy signature, or the entropy signature may be provided to the storage controller.

At 630, the storage controller compares the entropy determined at 620 with a reference entropy. The reference entropy may be retrieved or determined using one or more of the approaches already described (for example, from the metadata for the persistent storage device.) The comparison between the determined entropy and reference entropy at 630 can be implemented in any of the ways previously discussed with respect to 230 of FIG. 2.

Similarly, at 635, the storage controller evaluates the entropy signature that was determined at 625. The nature and details of the evaluation at 635 can be implemented in any of the ways previously discussed with respect to 530 of FIG. 5.

At 640, the storage controller determines a likelihood that the data is consistent with a ransomware attack. The determination is based at least partially on both the comparison between the determined entropy and reference entropy at 630 and the evaluation of the determined entropy signature at 635. The outcome of the comparison and evaluations may be weighted differently depending on the application of the storage controller. The determination may be a percentage or probability that the data is consistent with a ransomware attack.

The storage controller then aborts the write process at 650 or writes the data to the intended location at 660 depending at least partially on the likelihood determined at 640. The storage controller may optionally write the data whilst also flagging the data as being potentially consistent with a ransomware attack at 670. Other potential countermeasures that the storage controller may alternatively or additionally take can include reducing a write speed and/or raising an alert.

The example approach depicted in FIG. 6 uses a combination of a determined entropy for the data and an entropy signature. Such a combined approach can be useful in some instances to distinguish between compressed data, data which has been legitimately encrypted, and/or data that has been encrypted via ransomware.

For example, the storage controller can be configured so that the data received in the initial request at 610 is only considered to be consistent with a ransomware attack at 640 if the comparison at 630 and evaluation at 635 both fail.

For example, the reference entropy used in the comparison at 630 may be set to a high value such that data which has an entropy above this reference may be maliciously encrypted. Legitimately encrypted or compressed data may also occasionally have an entropy higher than this reference due to the inherently high entropy of encrypted/compressed data, and therefore may occasionally fail the comparison at 630. However, if the entropy signature of the data is also evaluated, it may be apparent that the data has patterns or portions within the entropy signature that can be used to fingerprint the data, and may suggest that the data is legitimate. In this example, the data would pass the evaluation at 635 despite failing the comparison at 630 and may proceed to be written to the intended location at 660.

In other examples, the storage controller may be configured so that the data received in the initial request at 610 is considered to be consistent with a ransomware attack at 640 if either one of the comparison at 630 or evaluation at 635 fails. For example, the storage controller may be configured to compare the determined entropy signature against a blacklist. An entropy signature determined from the received data may not be found in the blacklist and therefore may pass this evaluation, but the entropy of the data may be compared to the reference entropy and may be found to be above the reference entropy. The storage controller therefore may determine that the data corresponds to a ransomware attack and may either abort the write process or write the data whilst flagging the data as potential ransomware.

### Remedies

Although it has been described above that a write process may be aborted, in further embodiments the system may take an alternative approach.

In a first alternative, the write process may be slowed so as to limit the amount of data being written. For example, the write process may be slowed to near zero, without aborting the write process. This can prevent the write process being started again (which may occur in response to an aborted write) while enabling an operator to take appropriate action.

In a second alternative, a snapshot of the earlier state of the data may be taken and stored before the data is lost. This can allow an operator to restore the original data even after the write process has been completed.

### Requiring Minimum Entropy

Although approaches above have been described to take action when entropy is too high, in some cases the same approach may be used to take action when entropy is too low.

For example, the system may require that data is encrypted before being stored. This may be enforced by requiring a minimum level of entropy concordant with encrypted data, such as having a reference entropy with a value of 7.8, 7.9, or 7.99 or more. Where the entropy of written data falls below the reference entropy, the system may take any prophylactic action noted above, including aborting the write process.

### Interpretation

A number of methods have been described above. Any of these methods may be embodied in a series of instructions, which may form a computer program. These instructions, or this computer program, may be stored on a computer readable medium, which may be non-transitory. When executed, these instructions or this program cause a processor to perform the described methods. Additionally, or alternatively, any of the methods may be implemented in hardware, for example as an application-specific integrated circuit (ASIC).

Where an approach has been described as being implemented by a processor, this may comprise a plurality of processors. That is, at least in the case of processors, the singular should be interpreted as including the plural. Where methods comprise multiple steps, different steps or different parts of a step may be performed by different processors.

The steps of the methods have been described in a particular order for ease of understanding. However, the steps can be performed in a different order from that specified, or with steps being performed in parallel. This is the case in all methods except where one step is dependent on another having been performed.

The term “comprises” and other grammatical forms is intended to have an inclusive meaning unless otherwise noted. That is, they should be taken to mean an inclusion of the listed components, and possibly of other non-specified components or elements.

While the present invention has been explained by the description of certain embodiments, the invention is not restricted to these embodiments. It is possible to modify these embodiments without departing from the spirit or scope of the invention.

1. A method comprising:
receiving a request to write data at a virtual location;
determining an entropy for the data;
comparing the determined entropy to a reference entropy;
determining a likelihood that the data is consistent with a ransomware attack, wherein the determined likelihood is based at least partially on the comparison between the determined entropy and the reference entropy;
writing the data to the virtual location; and
writing the determined likelihood that the data is consistent with the ransomware attack to metadata at the virtual location.

2-3. (canceled)

4. The method of claim 1, wherein the reference entropy is based at least partially on an average of a plurality of previous entropies.

5. The method of claim 1, wherein the reference entropy is an upper threshold.

6. The method of claim 1, wherein the reference entropy corresponds to an entropy of an expected data source.

7. The method of claim 1, wherein the reference entropy corresponds to an entropy of a known data source.

8. The method of claim 1, wherein comparing the determined entropy to a reference entropy comprises a threshold test.

9. The method of claim 1, wherein the determined likelihood is proportional to a difference between the determined entropy and the reference entropy.

10. The method of claim 1, wherein the method further comprises applying a margin of uncertainty to the determined entropy.

11. The method of claim 1, wherein the method further comprises applying a margin of uncertainty to the reference entropy.

12. The method of claim 11, wherein the margin of uncertainty is a standard deviation.

13. A method comprising:
receiving a request to write data at a virtual location;
determining an entropy signature for the data;
evaluating the determined entropy signature;
determining a likelihood that the data is consistent with a ransomware attack, wherein the determined likelihood is based at least partially on the evaluation of the determined entropy signature,
writing the data to the virtual location; and
writing the determined likelihood that the data is consistent with the ransomware attack to metadata at the virtual location.

14. The method of claim 13, wherein evaluating the determined entropy signature comprises comparing at least a portion of the determined entropy signature to at least a portion of a reference entropy signature.

15. The method of claim 14, wherein the reference entropy signature corresponds to an entropy signature of an expected data source.

16. The method of claim 14, wherein the reference entropy signature is a whitelisted entropy signature.

17. The method of claim 14, wherein the reference entropy signature is a blacklisted entropy signature.

18. The method of claim 14, wherein the determined likelihood is proportional to a deviation between the at least portion of the determined entropy signature and the at least portion of the reference entropy signature.

19. The method of claim 13, wherein evaluating the determined entropy signature comprises comparing at least a portion of the determined entropy signature to at least one reference entropy.

20. The method of claim 19, wherein the determined likelihood is proportional to a deviation between the at least portion of the determined entropy signature and to the at least one reference entropy.

21. The method of claim 13, wherein evaluating the determined entropy signature comprises classifying the entropy signature using a trained machine learning model.
